(19) United States
(12) Patent Application Publication
(10) Pub. No.: US 2015/0267076 A1
(43) Pub. Date: Sep. 24, 2015

(54) Coating Compositions and Articles Made Therefrom

(71) Applicants: Rajan B. BODKHE, (US); Stuart E. FLORES, Bracknell, Berkshire (GB); Leon LEVITT, Saint Paul, MN (US); Craig M. MOSS, Saint Paul, MN (US); Michael A. JOHNSON, Saint Paul, MN (US); 3M INNOVATIVE PROPERTIES COMPANY, Saint Paul, MN (US)

(72) Inventors: Rajan B. Bodkhe, Woodbury, MN (US); Stuart E. Fores, County Durham (GB); Leon Levitt, Mendota Heights, MN (US); Craig M. Moss, Woodbury, MN (US); Michael A. Johnson, Stillwater, MN (US)

(73) Assignee: 3M INNOVATIVE PROPERTIES COMPANY

(21) Appl. No.: 14/432,828

(22) PCT Filed: Oct. 2, 2013
(86) PCT No.: PCT/US2013/062946

§ 371 Date: Apr. 1, 2015

Related U.S. Application Data
(60) Provisional application No. 61/709,274, filed on Oct. 3, 2012.

(51) Int. Cl. C09D 175/08; C08J 5/00; C08K 3/22; C08K 3/36; C08K 3/30

(52) U.S. Cl. CPC C09D 175/08; C08K 3/36; C08K 3/30; C08K 3/22; C08J 5/00; C08K 2003/2241; C08K 2003/3045; C08J 2375/08

(57) ABSTRACT

There is provided a coating composition comprising: (a) a one part moisture cure polyurethane comprising: an aromatic polyurethane prepolymer having backbone derived from polyether and at least one aromatic end group, wherein the coating composition comprises about 8 wt % to 90 wt % polyurethane prepolymer based on the total weight of the coating composition; (b) 2 to 60 wt % of an inorganic filler based on the total weight of the coating composition; and (c) 2 to 60 wt % of a solvent based on the total weight of the coating composition, wherein the coating composition, when cured, is a water-vapor semi-permeable, air and water barrier film. There is also provided a cured coating composition and articles made therefrom.

### FIELD OF THE INVENTION

The present disclosure relates to one part moisture cure polyurethane based coating composition useful for selectively allowing water vapor to pass at controlled rates but imparting air and water resistance. The composition of the present disclosure is used particularly for air and water barrier system for buildings.

### BACKGROUND

Air and water barrier systems control movement of air and water, and specifically water vapor, across a surface of a structure, such as a building enclosure. In exterior walls, uncontrolled air flow is the greatest source of moisture and condensation damage. Indoor comfort is affected by air temperature, relative humidity, direction of airflow and surrounding surface temperatures. Indoor air quality is enhanced by air and water barrier systems by keeping pollutants out of building interiors and is an efficient barrier systems in way of keeping pollutants out. Pollutants include water vapor, suspended particulates, dust, insects, smells, etc. Air and water barrier systems have significant impact on electricity consumption and gas bills. Air nonresidential buildings are estimated to reduce air leakage by up to 83 percent, saving on gas bill more than 40% and reducing electricity consumption more than 25% according to simulations by the National Institute of Standards and Technology (NIST) of typical buildings without air and water barriers. Water vapor is a key ingredient in corrosion and mold growth. Air and water barrier systems help prevent water vapor from being transported by air movement between exteriors and interiors of structures, such as buildings.

Use of air and water barrier systems has been a requirement in Canada for almost 25 years and is becoming important in North America due to net zero energy requirements by 2030, required by the US Army Corp of Engineering, ASHRAE 90, and International Energy Conservation Code—2009. On Dec. 16, 2011, the DC Construction Codes Coordinating Board (CCCB) adopted the 2012 International Energy Conservation Code (IECC). The code now is under administrative review and legislative process, with adoption likely in the second half of 2013.

### SUMMARY

There is a need for a coating composition that is semi-permeable. There is also a need for articles, films and a method of using these coating compositions.

In one aspect, the present disclosure provides a coating composition comprising: (a) a one part moisture cure polyurethane comprising: an aromatic polyurethane prepolymer having backbone derived from polyether and at least one aromatic end group, wherein the coating composition comprises about 8 wt % to 90 wt % polyurethane prepolymer based on the total weight of the coating composition; (b) 2 to 60 wt % of an inorganic filler based on the total weight of the coating composition; and (c) 2 to 60 wt % of a solvent based on the total weight of the coating composition, wherein the coating composition, when cured, is a water-vapor semi-permeable, air and water barrier film. In some embodiments, the water-vapor semi-permeable, air and water barrier film has a permeability of 1 perm to 10 perms according to ASTM E 96.

In some embodiments the water-vapor semi-permeable, air and water barrier film has a permeability of 3 perms to 8 perms according to ASTM E 96.

In some embodiments the coating composition further comprises 0.01 to 5 wt % of a catalyst based on the total weight of the coating composition. In some embodiments, the coating composition further comprises a moisture trigger additive. In some embodiments the moisture trigger additive is a bis(oxazolidine)-based moisture-triggered isocyanate. In some embodiments the coating composition further comprises 0.5 wt % to 1.5 wt % of a defoamer based on the total weight of the coating composition.

In some embodiments, the coating composition further comprises at least one of the following: 0.50 wt % to 10 wt % of a rheology modifier based on the total weight of the coating composition, 1 wt % to 60 wt % titanium dioxide based on the total weight of the composition, and 0 wt % to 60 wt % of a color pigment based on the total weight of the composition, and combinations thereof. In some embodiments, the coating composition further comprises a plasticizer, wherein the plasticizer does not react with the aromatic polyurethane prepolymer. In some embodiments, the coating composition is a liquid at ambient conditions. In some embodiments, the coating composition further comprises fillers.

In some embodiments, the one-part moisture-curable polyurethane further comprises an aliphatic isocyanate trimer. In some embodiments, the one-part moisture-curable polyurethane further comprises a second end group derived from an aromatic isocyanate. In some embodiments, the aromatic isocyanate is derived from; 1,3-phenylene diisocyanate (m-phenylene diisocyanate), 1,4-phenylene diisocyanate (p-phenylene diisocyanate), 2,6-toluene diisocyanate (2,6-TDI), 2,4-toluene diisocyanate (2,4-TDI), 1,5-naphthalene diisocyanate, diphenyl oxide 4,4′-diisocyanate, 4,4′-methylenediphenyl diisocyanate (4,4-MDI), 2,4′-methylenediphenyl diisocyanate (2,4-MDI), 2,2′-diisocyanatodiphenylmethane (2,2-MDI), diphenylmethanediisocyanate (MDI), 3,3′-dimethyl-4,4′-biphenylene isocyanate (tolidine diisocyanate), 3,3′-dimethoxy-4,4′-biphenylene diisocyanate (dianisidine diisocyanate), 1-[(2,4-diisocyanatophenyl)methyl]-3-isocyanato-2-methyl, 2,4,6-triisopropyl-m-phenylene diisocyanate, bis(4,4′-isocyanato-cylohexyl)methanes (H12MDI), 1,3- and 1,4-bis-(2-isocyanato-prop-2-yl)-benzene (TMXDI), triphenylinethane-4,4′,4″-triisocyanate or their and combinations thereof. In some embodiments, the coating composition has different end groups. In some embodiments, the polyether back bone has a number average molecular weight of at least 200 g/mol.

In another aspect, the present disclosure provides a cured coating composition comprising a one-part moisture-curable polyurethane comprising a polyether backbone and at least one end group derived from an aromatic isocyanate, wherein the cured coating composition has a permeability of 1 perm to 10 perms according to ASTM E 96. In some embodiments, the cured coating composition has a permeability of 3 perms to 8 perms according to ASTM E 96.

In another aspect, the present invention provides an article comprising a substrate coated with any of the aforementioned coating compositions or any of the aforementioned cured coating compositions. In some aspects, the coating is continuous.

In another aspect, the present disclosure provides a method of coating a substrate surface comprising applying any of the aforementioned coating compositions according to a substrate surface and allowing it to cure. In some embodiments, the coating composition is applied at an ambient temperature of −20° C. or higher.

Various aspects and advantages of exemplary embodiments of the present disclosure have been summarized. The above Summary is not intended to describe each illustrated embodiment or every implementation of the present disclosure. Further features and advantages are disclosed in the embodiments that follow. The Drawings and the Detailed Description that follow more particularly exemplify certain preferred embodiments using the principles disclosed herein.

### DETAILED DESCRIPTION

As used in this specification, the recitation of numerical ranges by endpoints includes all numbers subsumed within that range (e.g. 1 to 5 includes 1, 1.5, 2, 2.75, 3, 3.8, 4, and 5, and the like).

Unless otherwise indicated, all numbers expressing quantities or ingredients, measurement of properties and so forth used in the Specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

For the following defined terms, these definitions shall be applied for the entire Specification, including the claims, unless a different definition is provided in the claims or elsewhere in the Specification based upon a specific reference to a modification of a term used in the following Glossary:

### GLOSSARY

The words “a”, “an”, and “the” are used interchangeably with “at least one” to mean one or more of the elements being described.

The term “layer” refers to any material or combination of materials on or overlaying a substrate.

Words of orientation such as “atop, “on,” “covering,” “uppermost,” “overlaying,” “underlying” and the like for describing the location of various layers, refer to the relative position of a layer with respect to a horizontally-disposed, upwardly-facing substrate. It is not intended that the substrate, layers or articles encompassing the substrate and layers, should have any particular orientation in space during or after manufacture.

The term “separated by” to describe the position of a layer with respect to another layer and the substrate, or two other layers, means that the described layer is between, but not necessarily contiguous with, the other layer(s) and/or substrate.

The term “(co)polymer” or “(co)polymeric” includes homopolymers and copolymers, as well as homopolymers or copolymers that may be formed in a miscible blend, e.g., by coextrusion or by reaction, including, e.g., transesterification. The term “copolymer” includes random, block, graft, and star copolymers.

The term “semi permeable” as used herein means a film having a permeability of 1 to 10 perms according to ASTM E 96.

As used herein the term “diisocyanate” refers to a compound containing two isocyanate groups. As used herein the term “polyisocyanate” refers to a compound containing two or more isocyanate groups. Hence, diisocyanates are a subset of polyisocyanates.

The term “continuous” as used herein means a coating having an uninterrupted extension in along a two dimensional surface. For example, in some embodiments, an article having a continuous coating over a surface of a substrate may be a building envelope where the coating covers the entire outer surface of the building with no interruptions.

The term “liquid” as used herein means substances that have a definite volume but no fixed shape at ambient conditions. Exemplary liquids useful in the present disclosure include solutions, mixtures, emulsions and suspensions where the primary component in such solutions, mixtures, emulsions and/or suspensions have a definite volume but no fixed shape at ambient conditions.

The term “substrate” as used herein means construction materials including but not limited to exterior cladding materials and exterior sheathing materials.

The present disclosure provides one component, moisture cure polyurethane coating compositions that are useful in air and water barrier systems. The presently disclosed coating compositions can be applied by spray, liquid, roller, trowel, as an article and/or a film and are semi-permeable to water vapor and non permeable to air and water. In some embodiments, the presently disclosed coating composition is liquid at ambient conditions.

The presently disclosed coating compositions include a one-part moisture-curable polyurethane comprising a polyether back bone and at least one end group derived from an aromatic isocyanate. In some embodiments, the polyether back bone has a number average molecular weight of at least 200 g/mol, more preferably 500 g/mol, and most preferably 1000 g/mole.

In some embodiments, the one-part moisture-curable polyurethane includes a polyisocyanate. “Polyisocyanate” means any organic compound that has two or more reactive isocyanate (—NCO) groups in a single molecule such as diisocyanates, triisocyanates, tetraisocyanates, etc., and mixtures thereof. Polyisocyanate also includes oligomeric or polymeric isocyanates. Cyclic and/or linear polyisocyanate molecules may usefully be employed. For improved weathering and diminished yellowing, the polyisocyanate(s) of the isocyanate component is typically aliphatic. Useful aliphatic polyisocyanates include, for example, bis(4-isocyanatocyclohexyl) methane such as available from Bayer Corp., Pittsburgh, Pa. under the trade designation “DESMODUR W”; isophorone diisocyanate (IPDI) such as commercially available from Huels America, Piscataway, N.J.; hexamethylene diisocyanate (HDI) such as commercially available from Aldrich Chemical Co., Milwaukee, Wis.; trimethyl hexamethylene diisocyanate such as commercially available from Degussa, Corp., Dusseldorf, Germany under the trade designation “VESTANATE TMDI”; and m-tetramethylxylene diisocyanate (TMXDI) such as commercially available from Aldrich Chemical Co., Milwaukee, Wis. In some embodiments, the polyisocyanates include derivatives of the above-listed monomeric polyisocyanates. These derivatives include, but are not limited to, polyisocyanates containing biuret groups, such as the biuret adduct of hexamethylene diisocyanate (HDI) available from Bayer Corp. under the trade designation “DESMODUR N-100”, polyisocyanates containing isocyanurate groups, such as that available from Bayer Corp. under trade designation “DESMODUR N-3300” or “DESMODUR N-3900”, as well as polyisocyanates containing urethane groups, uretdione groups, carbodiimide groups, allophonate groups, and the like.

In some embodiments, the one-part moisture-curable polyurethane includes a bis(oxazolidine)-based moisture-triggered isocyanate.

In some embodiments, the one-part moisture-curable polyurethane includes a polyether back bone and at least one end groups derived from an aromatic isocyanate. In various embodiments, the polyisocyanate component may comprise polyisocyanates or polyisocyanate mixtures based on one or more aromatic diisocyanates, such as, for example benzene diisocyanate; toluene diisocyanate (TDI); diphenylmethane diisocyanate (MDI); isomers of any thereof; 1,3-phenylene diisocyanate (m-phenylene diisocyanate), 1,4-phenylene diisocyanate (p-phenylene diisocyanate), 2,6-toluene diisocyanate (2,6-TDI), 2,4-toluene diisocyanate (2,4-TDI), 1,5-naphthalene diisocyanate, diphenyl oxide 4,4′-diisocyanate, 4,4′-methylenediphenyl diisocyanate (4,4-MDI), 2,4′-methylenediphenyl diisocyanate (2,4-MDI), 2,2′-diisocyanatodiphenylmethane (2,2-MDI), diphenylmethanediisocyanate (MDI), 3,3′-dimethyl-4,4′-biphenylene isocyanate (tolidine diisocyanate), 3,3′-dimethoxy-4,4′-biphenylene diisocyanate (dianisidine diisocyanate), 1-[(2,4-diisocyanatophenyl)methyl]-3-isocyanato-2-methyl, 2,4,6-triisopropyl-m-phenylene diisocyanate, bis(4,4′-isocyanato-cyclohexyl)methanes (H12MDI), 1,3- and 1,4-bis-(2-isocyanato-prop-2-yl)-benzene (TMXDI), triphenylmethane-4,4′,4″-triisocyanate or their derivatives having a urethane, isocyanurate, aliophanate, biuret, uretdione, iminooxadiazinedione structure and/or mixtures thereof as well as mixtures of aliphatic and aromatic diisocyanates and/or polyisocyanates. The production of such derivatives is known and described, for example, in U.S. Pat. Nos. 3,124,605, 3,183,112, 3,919,218, and 4,324,879 and in EP 798 299.

In some embodiments, both end groups are derived from the same aromatic isocyanate. In some embodiments, the end groups are derived from different aromatic isocyanates.

In some embodiments, the coating composition comprises urethane bisoxazolidine latent hardener, IPDI ((isophorone diisocyanate) trimer. In some embodiments, the presently disclosed coating composition comprises at least 10 wt % one-part moisture-curable polyurethane, more preferably 20 wt % one-part moisture-curable polyurethane, and most preferably 40 wt % one-part moisture-curable polyurethane, based on the total weight of the coating composition.

In some embodiments, the coating composition comprises plasticizers. In some embodiments, the coating composition can be produced with additional use of plasticizers in which case the plasticizers used do not contain any groups reactive toward isocyanates. Plasticizers useful in the coating compositions of this disclosure include esters of organic carboxylic acids or anhydrides thereof, such as phthalates, for example dioctyl phthalate, diisononyl phthalate or diisodecyl phthalate, adipates, for example dioctyl adipate, azelates and sebacates. Specific examples are the dialkyl phthalates such as di-(2-ethyl-hexyl)-pththalates, dibutyl phthalate, diethyl phthalate, dioctyl phthalate, butyl octyl phthalate; dicyclohexyl phthalate, butyl benzyl phthalate; triaryl phosphates such as tricresyl phosphate, triphenyl phosphate, cresyl(liphenyl phosphate; trialkyl phosphates such as trioctyl phosphate and tributyl phosphate; alkoxyalkyl phosphates such as trisbutoxyethyl phosphate: alkyl aryl phosphates such as octyldiphenyl phosphate; alkyl adipates such as di-(2-ethylhexyl)adipate, diisooctyl adipate, octyl decyladinate; dialkyl sebacates such as dibutyl sebacate, dioctylsebacate, diisooctyl sebacate; alkyl azelates such as di(2-ethylhexyl)azelate and di-(2-ethylbutyl)azelate; citrates such as acetyl tri-n-butyl citrate, acetyl triethyl citrate, monoisopropyl citrate, triethyl citrate, mono-, di-, and tri--stearyl citrate; triacetin, p-tert-butyl and mixtures thereof. When plasticizer is used, the amount of plasticizer used depends on the selection of aromatic polyurethane prepolymer and plasticizer used in the coating composition.

Other ingredients useful in the presently disclosed coating compositions include antifoaming agents, wetting and dispersing agents, rheology modifiers, catalysts, pigments, extenders, solvents, fillers, light stabilizers and/or UV absorbers, dehydrators, and color additives.

In some embodiments, the presently disclosed coating compositions may comprise one or more additives, such as, for example, “JONCRYL® 611” (BASF Corporation) and/or “NEOCRYL B734” (DSM N.V.). JONCRYL® 611 is a styrene-acrylic acid copolymer. JONCRYL® 611 may be used as a dispersing agent in a moisture-curable coating composition to affect pigment dispersion and film-forming properties, for example. NEOCRYL B-734 is a methyl methacrylate, n-butyl methacrylate copolymer resin. NEOCRYL B734 may be used as a dispersing agent to affect pigment dispersion and film-forming properties, for example.

In some embodiments, the presently disclosed coating compositions may comprise one or more pigments or fillers. Useful fillers are typically solids that are non-reactive with the other components of the compositions of the invention. Useful fillers include, for example, clay, talc, dye particles, pigments and colorants (for example, TiO₂ or carbon black), glass beads, metal oxide particles, silica particles, ceramic microspheres, hollow polymeric microspheres (such as those available under the trade designation EXPANCEL 551 DE from Akzo Nobel, Duluth, Ga.), hollow glass microspheres (such as those available under the trade designation K37 from Minnesota Mining and Manufacturing Co., St Paul, Minn.), carbonates, metal oxides, silicates (e.g. talc, asbestos, clays, mica), sulfates, silicon dioxide and aluminum trihydrate.

Some specific examples include ground or light calcium carbonate (with or without a surface-treatment such as a fatty acid, resin acid, cationic surfactant, or anionic surfactant); magnesium carbonate; talc; sulfates such as barium sulfate; alumina; metals in powder form (e.g., aluminum, zinc and iron); bentonite; kaolin clay; quartz powder; and combinations of two or more.

Examples of useful organic pigments include halogenated copper phthalocyanines, aniline blacks, anthraquinone blacks, benzimidazolones, azo condensations, arylamides, diarylides, disazo condensations, isoindolinones, isoindolines, quinophthalones, anthrapyrimidines, flavanthrones, pyrazolone oranges, perinone oranges, beta-naphthols, BON arylamides, quinacridones, perylenes, anthraquinones, dibromanthrones, pyranthrones, diketopyrrolo-pyrrole pigments (DPP), dioxazine violets, copper and copper-free phthalocyanines, indanthrones, and the like.

Examples of useful inorganic pigments include titanium dioxide, zinc oxide, zinc sulphide, lithopone, antimony oxide, barium sulfate, carbon black, graphite, black iron oxide, black micaceous iron oxide, brown iron oxides, metal complex browns, lead chromate, cadmium yellow, yellow oxides, bismuth vanadate, lead chromate, lead molybdate, cadmium red, red iron oxide, Prussian blue, ultramarine, cobalt blue, chrome green (Brunswick green), chromium oxide, hydrated chromium oxide, organic metal complexes, laked dye pigments and the like.

The filler can also comprise conductive particles (see, for example, U.S. Patent Application Pub. No. 2003/0051807) such as carbon particles or metal particles of silver, copper, nickel, gold, tin, zinc, platinum, palladium, iron, tungsten, molybdenum, solder or the like, or particles prepared by covering the surface of these particles with a conductive coating of a metal or the like. It is also possible to use non-conductive particles of a polymer such as polyethylene, polystyrene, phenol resin, epoxy resin, acryl resin or benzoguanamine resin, or glass beads, silica, graphite or a ceramic, whose surfaces have been covered with a conductive coating of a metal or the like.

Preferred fillers include inorganic solids such, for example, talc, titanium dioxide, silica, zirconia, calcium carbonate, calcium magnesium carbonate, glass or ceramic microspheres, and combinations thereof. In some embodiments, titanium dioxide and/or calcium carbonate are preferred.

In some embodiments, the coating composition of the present disclosure may comprise one or more pigment wetting agents or dispersants. Pigment wetting agents and dispersants that may be useful in the present disclosure may include, for example, DISPERBYK®-110 (BYK-Chemie GmbH), DISPERBYK®-192 (BYK-Chemie GmbH), and/or ANTI-TERRA U (BYK-Chemie GmbH).

The coating composition may comprise one or more rheology modifiers. Rheology modifiers useful in the present disclosure may include, for example, BYK® 430, BYK® 431 (BYK-Chemie GmbH), Bentonite clays, and/or castor oil derivatives. In some embodiments, the presently disclosed coating composition may comprise one or more antifoaming agents. Antifoaming agents useful in the present disclosure may include, for example, BYK® 077 (BYK-Chemie GmbH).

In some embodiments, the presently disclosed coating compositions may comprise one or more light stabilizers and/or UV-absorbers. Light stabilizers useful in the present disclosure may include, for example, TINUVIN® 292 (Ciba/BASF). UV-absorbers that may find utility in the presently disclosed coating composition may include, for example, TINUVIN® 1130 (Ciba/BASF). In some embodiments, the coating composition may comprise one or more dehydrators. Dehydrators useful in the presently disclosed coating composition may include, for example, p-toluenesulfonyl isocyanate, isophorone diisocyanate, and/or hexamethylene diisocyanate.

In some embodiments, the presently disclosed coating composition may comprise one or more catalysts, such as, for example, dibutyltin dilaurate or a tertiary amine, to accelerate the curing reaction. Catalysts that may find utility in the present disclosed coating composition may include, for example, DABCO® T-12 (Air Products and Chemicals, Inc.) and/or 1,4-diazabicyclo[2.2.2]octane. Other useful catalysts for the present disclosure include, but are not limited to, those catalysts that include both ether and morpholine functional groups, e.g., with 2,2-dimorpholinoethyl ether and di(2,6-dimethyl morpholinoethyl)ether. A useful catalyst is 4,4′-(oxydi-2,1-ethanediyl)bis-morpholine, which known in the trade as DMDEE and is commercially available under the trade designation “JEFFCATE DMDEE” from Huntsman Corp. (Houston, Tex.).

Other useful catalysts include, e.g., organo tin catalysts, e.g., dibutyl tin dilaurate, and bismuth catalysts. Bismuth octoate is a very good moisture cure catalyst, but is not as stable as some catalysts during shipping and storage where the temperatures may reach about 65° C.

The catalyst is preferably present in the presently disclosed coating composition in an amount of from about 0.05% by weight about 5% by weight, more preferably from about 0.1% by weight to about 2% by weight, most preferably from about 0.1% by weight to about 1% by weight.

The coating composition may comprise one or more additional additives. Additional additives that may find utility in the presently disclosed coating composition may include, for example, those commercially available under the trade designations BYK® 358, and/or BYK® 306 (BYK-Chemie GmbH).

In some embodiments, the coating composition may comprise one or more solvents. Solvent should be non-reactive with isocyanate and examples of such includes aliphatic, aromatic or araliphatic solvent which do not contain any cerivitinov-active hydrogen atoms but do preferably contain ether groups and/or ester groups and/or halogen atoms and/or nitrile groups and/or amide groups. Examples of suitable solvent include methoxypropyl acetate, methoxyethyl acetate, ethylene glycol diacetate, propylene glycol diacetate, glyme, diglyme, dioxane, tetrahydrofuran, dioxolane, tert-butyl methyl ether, ethyl acetate, butyl acetate, chloroform, methylene chloride, chlorobenzene, o-dichlorobenzene, anisole, 1,2-dimethoxybenzene, phenyl acetate, N-methyl-2-pyrrolidone, dimethylformamide, N,N-dimethylacetamide, dimethyl sulphoxide, acetonitrile, phenoxyethyl acetate and/or mixtures thereof, preferably solvent containing ether and ester groups, such as methoxypropyl acetate, acetone, 2-butano e, xylene, toluene, cyclohexanone, 4-methyl-2-pentanone, 1-methoxyprop-2-yl acetate, ethylene glycol monomethyl or -ethyl ether-acetate, 3-methoxy-n-butyl acetate, white spirit, more highly substituted aromatics such as are commercially available, for example, under the names solvents Naphtha, “SOLVESSO”, “ISOPAR”, “NAPPAR” (Deutsche EXXON CHEMICAL GmbH, Cologne, DE) and “SHELLSOL” (Deutsche Shell Chemie GmbH, Eschborn, DE)., methyl n-amyl ketone (“MAK”), “AROMATIC 100” (ExxonMobile Chemical), “AROMATIC 150” (ExxonMobile Chemical), xylene, methyl isobutyl ketone (“MIBK”), ethyl 3-ethoxypropionate (Eastman™ EEP solvent, Eastman Chemical Company), and/or methyl ethyl ketone (“MEK”).

In some embodiments, the presently disclosed coating composition is used to make an article having a substrate coated with a coating comprising the presently disclosed coating composition. In some embodiments, the coating is continuous. In some embodiments, thickness of the coating is varied to achieve desired permeability of the article. In some embodiments, the amount of aromatic polyurethane and molecular weight of polyether backbone used in the coating composition is varied to achieve desired permeability of the article. In some embodiments, the aromatic polyurethane and molecular weight of polyether backbone used in the coating composition and the thickness of the coating are varied to achieve desired permeability of the article.

The present disclosure provides a film made using the presently disclosed coating composition. In some embodiments, the film has a permeability of 1 perm to 10 perms according to ASTM E 96. In some embodiments, the film has a permeability of 3 perms to 8 perms according to ASTM E 96. In some embodiments, the presently disclosed films have at least 100% elongation and moisture vapor transmission rates of 1 perms to 10 perms according to ASTM E 96. In some embodiments, thickness of the coating is varied to achieve desired permeability of the film. In some embodiments, the amount of aromatic polyurethane with polyether backbone used in the coating composition, which is used in the film, is varied to achieve desired permeability of the film.

The presently disclosed coating composition is useful in a method of coating a substrate surface including the steps of applying the presently disclosed coating composition to a substrate surface and allowing it to cure. In some embodiments, the coating composition is applied at an ambient temperature of −20° C. or higher.

The present disclosure further provides a method for preventing air and water transport across a surface of a structure but allowing water vapor transport across the surface of the structure comprising (a) coating at least a portion of the surface of the structure with a coating composition comprising: a one-part moisture-curable polyurethane comprising a polyether back bone and at least one end group derived from an aromatic isocyanate. In some embodiments, the structure is a building. In some embodiments, the coating composition, article and/or film is applied on construction materials including but not limited to exterior cladding materials and exterior sheathing materials. Useful exterior sheathing materials include but are not limited to plywood, oriented strand board (OSB), foam insulation sheathing, nonwoven glass mat faced gypsum sheathing board, or other conventional sheathing materials commonly used in the construction industry. Useful include but are not limited to exterior cladding layer brick, concrete blocks, reinforced concrete, stone, vinyl siding, fiber cement board, clapboard, or other known exterior siding materials.

Exemplary embodiments of the present disclosure have been described above and are further illustrated below by way of the following Examples, which are not to be construed in any way as imposing limitations upon the scope of the present disclosure. On the contrary, it is to be clearly understood that resort may be had to various other embodiments, modifications, and equivalents thereof which, after reading the description herein, may suggest themselves to those skilled in the art without departing from the spirit of the present disclosure and/or the scope of the appended claims.

Following are various embodiments of the present disclosure:

1. A coating composition comprising:

(a) a one part moisture cure polyurethane comprising: an aromatic polyurethane prepolymer having backbone derived from polyether and at least one aromatic end group, wherein the coating composition comprises about 8 wt % to 90 wt % polyurethane prepolymer based on the total weight of the coating composition;

(b) 2 to 60 wt % of an inorganic filler based on the total weight of the coating composition; and

(c) 2 to 60 wt % of a solvent based on the total weight of the coating composition,

wherein the coating composition, when cured, is a water-vapor semi-permeable, air and water barrier film.
2. The coating composition of embodiment 1 wherein the water-vapor semi-permeable, air and water barrier film has a permeability of 1 perm to 10 perms according to ASTM E 96.
3. The coating composition of embodiment 1 wherein the water-vapor semi-permeable, air and water barrier film has a permeability of 3 perms to 8 perms according to ASTM E 96.
4. The coating composition of any of the preceding embodiments further comprising 0.01 to 5 wt % of a catalyst based on the total weight of the coating composition.
5. The coating composition of any of the preceding embodiments further comprising a moisture trigger additive.
6. The coating composition of embodiment 5 wherein the moisture trigger additive is a bis(oxazolidine)-based moisture-triggered isocyanate.
7. The coating composition of any of the preceding embodiments further comprising 0.5 wt % to 1.5 wt % of a defoamer based on the total weight of the coating composition.
8. The coating composition of any of the preceding embodiments further comprising at least one of the following: 0.50 wt % to 10 wt % of a rheology modifier based on the total weight of the coating composition, 1 wt % to 60 wt % titanium dioxide based on the total weight of the composition, and 0 wt % to 60 wt % of a color pigment based on the total weight of the composition, and combinations thereof.
9. The composition of any of the preceding embodiments further comprising a plasticizer, wherein the plasticizer does not react with the aromatic polyurethane prepolymer.
10. The composition of any of the preceding embodiments wherein the coating composition is a liquid at ambient conditions.
11. The composition of any of the preceding embodiments further comprising fillers.
12. The composition of any of the preceding embodiments wherein the one-part moisture-curable polyurethane further comprises an aliphatic isocyanate trimer.
13. The composition of any of the preceding embodiments wherein the one-part moisture-curable polyurethane further comprises a second end group derived from an aromatic isocyanate.
14. The composition of embodiment 13 wherein the aromatic isocyanate is derived from; 1,3-phenylene diisocyanate (m-phenylene diisocyanate), 1,4-phenylene diisocyanate (p-phenylene diisocyanate), 2,6-toluene diisocyanate (2,6-TDI), 2,4-toluene diisocyanate (2,4-TDI), 1,5-naphthalene diisocyanate, diphenyl oxide 4,4′-diisocyanate, 4,4′-methylenediphenyl diisocyanate (4,4-MDI), 2,4′-methylenediphenyl diisocyanate (2,4-MDI), 2,2′-diisocyanatodiphenylmethane (2,2-MDI), diphenylmethanediisocyanate (MDI), 3,3′-dimethyl-4,4′-biphenylene isocyanate (tolidine diisocyanate), 3,3′-dimethoxy-4,4′-biphenylene diisocyanate (dianisidine diisocyanate), 1-[(2,4-diisocyanatophenyl)methyl]-3-isocyanato-2-methyl, 2,4,6-triisopropyl-m-phenylene diisocyanate, bis(4,4′-isocyanato-cyclohexyl)methanes (H12MDI), 1,3- and 1,4-bis-(2-isocyanato-prop-2-yl)-benzene (TMXDI), triphenylmethane-4,4′,4″-triisocyanate or their and combinations thereof.
15. The composition of embodiments 13 or 14 wherein the end groups are different.
16. The composition of any of the preceding embodiments wherein the polyether back bone has a number average molecular weight of at least 200 g/mol.
17. A cured coating composition comprising a one-part moisture-curable polyurethane comprising a polyether backbone and at least one end group derived from an aromatic isocyanate, wherein the cured coating composition has a permeability of 1 perm to 10 perms according to ASTM E 96.
18. The cured coating composition of embodiment 17 wherein the cured coating composition has a permeability of 3 perms to 8 perms according to ASTM E 96.
19. An article comprising a substrate coated with a coating comprising the coating composition of any of embodiments 1 to 16 or the cured coating composition of embodiments 17 or 18.
20. The article of embodiment 19 wherein the coating is continuous.
21. A method of coating a substrate surface comprising applying the coating composition according to any of embodiments 1 to 16 to a substrate surface and allowing it to cure.
22. The method of embodiment 21 wherein the coating composition is applied at an ambient temperature of −20° C. or higher.

### EXAMPLES

The following examples are intended to illustrate exemplary embodiments within the scope of this disclosure. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Materials

| Designation | Description |
|---|---|
| DESMODUR LD | Solvent-free, low-viscosity liquid, low-functionality aliphatic |
| | isocyanate resin based on hexamethylenediisocyanate, |
| | obtained from Bayer Materials Science, Pittsburgh, PA |
| DESMODUR E15 | Solvent-free, aromatic polyisocyanate prepolymer based on |
| | toluene diisocyanate (TDI) obtained from Bayer Materials |
| | Science, Pittsburgh, PA |
| DESMODUR E14 | Solvent-free, linear, aromatic prepolymer based on toluene |
| | diisocyanate (TDI), obtained from Bayer Materials Science, |
| | Pittsburgh, PA |
| DESMODUR E22 | Solvent-free, aromatic polyisocyanate prepolymer based on |
| | diphenylmethane diisocyanate, obtained from Bayer Materials |
| | Science, Pittsburgh, PA |
| BEHP | bis-(2-ethylhexyl)phthalate, a phthalate based plasticizer |
| | obtained from Alfa Aesar, Ward Hill, MA |
| DOP | Doctylphtalate, a phthalate based plasticizer obtained from |
| | ChemCeed, Chippewa Falls, WI |
| MESOMOLL | The phthalate-free plasticizer obtained from LANXESS Corp, |
| | Pittsburgh, PA |
| DINP | Disononylphtalate, a phthalate based plasticizer obtained from |
| | ChemCeed, Chippewa Falls, WI |
| DESMODUR Z 4470 MPA/X | Aliphatic polyisocyanate (IPDI trimer), as hardener |
| | component, 70% in 1-methoxypropylacetate-2, obtained from |
| | Bayer Materials Science, Pittsburgh, PA |
| DESMODUR VPLS 2959 | Aliphatic latent hardener, 100%, obtained from Bayer |
| | Materials Science, Pittsburgh, PA |
| BYK A530 | Silicone polymer air release additive, obtained from BYK |
| | USA, Inc., Wallingford, CT |
| MPA | Methoxy propyl acetate, obtained from Sigma-Aldrich |
| | Chemical Company, St. Louis, MO |
| AX | Aromatic xylene, obtained from Sigma-Aldrich Chemical |
| | Company, St. Louis, MO |
| PTSI | para-toluene sulfonyl isocyanate, obtained from Sigma- |
| | Aldrich Chemical Company, St. Louis, MO |
| DABCO T-12 | Dibutyltindilaurate catalyst, 5% in xylene, obtained from Air |
| | Products, Inc., Allentown, PA |
| CAB-O-SIL TS-720 | Medium surface area fumed silica which has been surface |
| | modified with polydimethylsiloxane, obtained from Cabot |
| | Corp., Billerica, MA |
| AIRWHITE ULTRA | Barium sulfate, obtained from Viaton Industries, Inc., |
| | Derbyshire, England |
| TIONA 696 | Rutile titanium dioxide, obtained from Cristal Global, Jeddah, |
| | Saudi Arabia |

### Test Methods

Moisture vapor transmittance rate (MVTR) of the example samples described below were determined in accordance with the ASTM E96 (2010) “Standard test method for water vapor transmission of materials”, obtained from IHS Inc., Englewood, Colo.

Tensile and elongation testing (conical mandrel testing) of the example samples described below were determined in accordance with the ASTM D412 (2008) “Standard test method for vulcanized rubber and thermoplastic elastomers-tension”, obtained from IHS Inc., Englewood, Colo.

### Examples 1-10

### EX1-EX10

Each of EX1-EX10 samples were prepared from moisture cure polyurethane coating compositions made by mixing resins, pigments, specialty additives and solvents. Table 1, below summarizes the formulations for each of EX1-EX7 coating compositions. Table 2, below summarizes the formulations for each of EX8-EX10 coating compositions. To prepare each coating composition, the desired ingredients were charged into a mixing vessel. The vessel was placed in a mixer (dual asymmetric centrifuge mixer, obtained under the trade designation “150 DAC SpeedMixer” from Flacktek, Inc Landrum, S.C.) and the contents were mixed at 2500 rounds per minute (rpm) for 4 minutes. The resulting slurries were then applied on a TEFLON sheet by using a drawdown coater (Multiple Clearance Applicator PA-5357 with a 40 mil (1.02 mm) clearance gap, obtained from BYK Gardner GmbH, Geretsried, Md.) to form a coating with about a 40 mil (1.02 mm) wet thickness. The coatings were allowed to cure at 20° C. for 7 days. After curing the cured films were separated from the TEFLON sheet and the recovered cured film samples were tested. MVTR of the cured EX1-EX10 samples were determined and summarized in Table 3, below. The tensile and elongation testing of the cured EX1-EX10 samples were determined and summarized in Table 4, below.

TABLE 1
Ingredients of

| Coating | Amount added (g) | | | | | | |
|---|---|---|---|---|---|---|---|
| Composition | EX 1 | EX 2 | EX 3 | EX 4 | EX 5 | EX 6 | EX 7 |
| BEHP | 8.00 | 0.00 | 0.00 | 0.00 | 8.00 | 0.00 | 0.00 |
| DOP | 0.00 | 8.00 | 0.00 | 0.00 | 0.00 | 0.00 | 0.00 |
| MESOMOLL | 0.00 | 0.00 | 8.00 | 0.00 | 0.00 | 8.00 | 0.00 |
| DINP | 0.00 | 0.00 | 0.00 | 8.00 | 0.00 | 0.00 | 8.00 |
| MPA | 5.00 | 5.00 | 5.00 | 5.00 | 3.00 | 3.00 | 3.00 |
| BYK A530 | 0.50 | 0.50 | 0.50 | 0.50 | 0.50 | 0.50 | 0.50 |
| DABCO T-12 | 2.00 | 2.00 | 2.00 | 2.00 | 2.00 | 2.00 | 2.00 |
| PTSI | 3.00 | 3.00 | 3.00 | 3.00 | 3.00 | 3.00 | 3.00 |
| AIRWHITE | 34.45 | 34.45 | 34.45 | 34.45 | 32.00 | 32.00 | 32.00 |
| ULTRA | | | | | | | |
| CAB-OSIL | 1.50 | 1.50 | 1.50 | 1.50 | 1.50 | 1.50 | 1.50 |
| TS720 | | | | | | | |
| DESMODUR | 36.90 | 36.90 | 36.90 | 36.90 | 0.00 | 0.00 | 0.00 |
| E15 | | | | | | | |
| DESMODUR | 0.00 | 0.00 | 0.00 | 0.00 | 45.00 | 45.00 | 45.00 |
| E14 | | | | | | | |
| DESMODUR | 1.80 | 1.80 | 1.80 | 1.80 | 1.80 | 1.80 | 1.80 |
| Z 4470 MPA/X | | | | | | | |
| DESMODUR | 3.10 | 3.10 | 3.10 | 3.10 | 3.10 | 3.10 | 3.10 |
| VPLS 2959 | | | | | | | |
| AX | 0.75 | 0.75 | 0.75 | 0.75 | 0.75 | 0.75 | 0.75 |
| Total weight | 97.00 | 97.00 | 97.00 | 97.00 | 100.65 | 100.65 | 100.65 |

TABLE 2

| Ingredients of | | | |
|---|---|---|---|
| Coating | Amount added (g) | | |
| Composition | EX 8 | EX 9 | EX 10 |
| MESOMOLL | 10.00 | 3.00 | 0.00 |
| DESMODUR LD | 5.44 | 5.44 | 5.44 |
| MPA | 6.50 | 6.50 | 6.50 |
| BYK A530 | 0.50 | 0.50 | 0.50 |
| DABCO T 12 | 2.00 | 2.00 | 2.00 |
| PTSI | 2.00 | 2.00 | 2.00 |
| TIONA 696 | 1.00 | 1.00 | 1.00 |
| AIRWHITE ULTRA | 27.00 | 28.00 | 27.00 |
| CAB-OSIL TS720 | 1.50 | 1.50 | 1.50 |
| DESMODUR E15 | 28.00 | 28.00 | 28.00 |
| DESMODUR E22 | 6.30 | 6.30 | 6.30 |
| DESMODUR Z | 1.80 | 1.80 | 1.80 |
| 4470 MPA/X | | | |
| DESMODUR | 5.00 | 5.00 | 5.00 |
| VPLS 2959 | | | |
| AX | 2.75 | 8.96 | 10.96 |
| Total weight | 99.79 | 100.00 | 98.00 |

TABLE 3

| | Sample Thickness | Permeance | Permeability |
|---|---|---|---|
| Sample | (cm) | (perms) | (perm*cm) |
| EX1 | 0.035 | 4.81 | 0.171 |
| EX2 | 0.033 | 7.69 | 0.254 |
| EX3 | 0.036 | 6.61 | 0.243 |
| EX4 | 0.035 | 7.74 | 0.275 |
| EX5 | 0.059 | 5.80 | 0.346 |
| EX6 | 0.068 | 6.77 | 0.464 |
| EX7 | 0.063 | 7.74 | 0.491 |
| EX8 | 0.049 | 3.75 | 0.186 |
| EX9 | 0.055 | 4.32 | 0.241 |
| EX 10 | 0.048 | 4.37 | 0.211 |

TABLE 4

| | Width | Thickness | Strain At | Modulus | Energy To | Load At | Strain At | Break Stress | Elongation At |
|---|---|---|---|---|---|---|---|---|---|
| Sample | (cm) | (cm) | Break % | (MPa) | Break (N*m) | Yield (N) | Yield % | (MPa) | Break (cm) |
| EX1 | 0.64 | 0.035 | 243.12 | 2.384 | 0.216 | 5.916 | 260.40 | 2.479 | 6.172 |
| EX2 | 0.64 | 0.033 | 221.85 | 2.595 | 0.191 | 5.560 | 226.17 | 2.565 | 5.639 |
| EX3 | 0.64 | 0.036 | 227.89 | 2.616 | 0.209 | 5.783 | 224.20 | 2.564 | 5.791 |
| EX4 | 0.64 | 0.035 | 222.13 | 2.542 | 0.199 | 5.694 | 219.05 | 2.496 | 5.639 |
| EX5 | 0.64 | 0.059 | 153.43 | 2.698 | 0.155 | 6.539 | 158.56 | 2.018 | 3.886 |
| EX6 | 0.64 | 0.068 | 143.98 | 2.616 | 0.172 | 7.517 | 144.59 | 1.903 | 3.658 |
| EX7 | 0.64 | 0.063 | 143.72 | 2.636 | 0.171 | 7.606 | 143.88 | 1.907 | 3.658 |
| EX8 | 0.64 | 0.049 | 451.18 | 0.272 | 0.226 | 3.336 | 400.51 | 1.029 | 11.455 |
| EX9 | 0.64 | 0.055 | 546.46 | 0.608 | 0.802 | 10.097 | 546.46 | 3.213 | 13.868 |
| EX 10 | 0.64 | 0.048 | 332.72 | 0.726 | 0.259 | 5.916 | 334.20 | 1.902 | 8.458 |

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. Furthermore, all publications, published patent applications and issued patents referenced herein are incorporated by reference in their entirety to the same extent as if each individual publication or patent was specifically and individually indicated to be incorporated by reference. Various exemplary embodiments have been described. These and other embodiments are within the scope of the following listing of disclosed embodiments.

1. A coating composition comprising:
(a) a one part moisture cure polyurethane comprising: an aromatic polyurethane prepolymer having backbone derived from polyether and at least one aromatic end group, wherein the coating composition comprises about 8 wt % to 90 wt % polyurethane prepolymer based on the total weight of the coating composition;
(b) 2 to 60 wt % of an inorganic filler based on the total weight of the coating composition; and
(c) 2 to 60 wt % of a solvent based on the total weight of the coating composition, wherein the coating composition, when cured, is a water-vapor semi-permeable, air and water barrier film,
wherein the water-vapor semi-permeable, air and water barrier film has a permeability of 1 perm to 10 perms according to ASTM E 96.

2. (canceled)

3. The coating composition of claim 1 wherein the water-vapor semi-permeable, air and water barrier film has a permeability of 3 perms to 8 perms according to ASTM E 96.

4. The coating composition of claim 1 further comprising 0.01 to 5 wt % of a catalyst based on the total weight of the coating composition.

5. The coating composition of claim 1 further comprising a moisture trigger additive.

6. The coating composition of claim 5 wherein the moisture trigger additive is a bis(oxazolidine)-based moisture-triggered isocyanate.

7. The coating composition of claim 1 further comprising 0.5 wt % to 1.5 wt % of a defoamer based on the total weight of the coating composition.

8. The coating composition of claim 1 further comprising at least one of the following: 0.50 wt % to 10 wt % of a rheology modifier based on the total weight of the coating composition, 1 wt % to 60 wt % titanium dioxide based on the total weight of the composition, and 0 wt % to 60 wt % of a color pigment based on the total weight of the composition, and combinations thereof.

9. The composition of claim 1 further comprising a plasticizer, wherein the plasticizer does not react with the aromatic polyurethane prepolymer.

10. The composition of claim 1 wherein the coating composition is a liquid at ambient conditions.

11. The composition of claim 1 further comprising fillers.

12. The composition of claim 1 wherein the one-part moisture-curable polyurethane further comprises an aliphatic isocyanate trimer.

13. The composition of claim 1 wherein the one-part moisture-curable polyurethane further comprises a second end group derived from an aromatic isocyanate.

14. The composition of claim 13 wherein the aromatic isocyanate is derived from; 1,3-phenylene diisocyanate (m-phenylene diisocyanate), 1,4-phenylene diisocyanate (p-phenylene diisocyanate), 2,6-toluene diisocyanate (2,6-TDI), 2,4-toluene diisocyanate (2,4-TDI), 1,5-naphthalene diisocyanate, diphenyl oxide 4,4′-diisocyanate, 4,4′-methylenediphenyl diisocyanate (4,4-MDI), 2,4′-methylenediphenyl diisocyanate (2,4-MDI), 2,2′-diisocyanatodiphenylmethane (2,2-MDI), diphenylmethanediisocyanate (MDI), 3,3′-dimethyl-4,4′-biphenylene isocyanate (tolidine diisocyanate), 3,3′-dimethoxy-4,4′-biphenylene diisocyanate (dianisidine diisocyanate), 1-[(2,4-diisocyanatophenyl)methyl]-3-isocyanato-2-methyl, 2,4,6-triisopropyl-m-phenylene diisocyanate, bis(4,4′-isocyanato-cyclohexyl)methanes (H12MDI), 1,3- and 1,4-bis-(2-isocyanato-prop-2-yl)-benzene (TMXDI), triphenylmethane-4,4′4″-triisocyanate or their and combinations thereof.

15. The composition of claim 13 wherein the end groups are different.

16. The composition of claim 1 wherein the polyether back bone has a number average molecular weight of at least 200 g/mol.

17. A cured coating composition comprising a one-part moisture-curable polyurethane comprising a polyether backbone and at least one end group derived from an aromatic isocyanate, wherein the cured coating composition has a permeability of 1 perm to 10 perms according to ASTM E 96.

18. The cured coating composition of claim 17 wherein the cured coating composition has a permeability of 3 perms to 8 perms according to ASTM E 96.

19. An article comprising a substrate coated with a coating comprising the coating composition of claim 1.

20. The article of claim 19 wherein the coating is continuous.

21. A method of coating a substrate surface comprising applying the coating composition according to claim 1 to a substrate surface and allowing it to cure.

22. The method of claim 21 wherein the coating composition is applied at an ambient temperature of −20° C. or higher.
